(19) United States
(12) Patent Application Publication
(10) Pub. No.: US 2023/0029746 A1
(43) Pub. Date: Feb. 2, 2023

(54) MAPPING SUBSURFACE INFRASTRUCTURE

(71) Applicant: Prezerv Technologies, Boston, MA (US)

(72) Inventors: Cambiz Nick Raufi, Somerville, MA (US); Alessandro Morari, Everett, MA (US); Giacomo Domeniconi, White Plains, NY (US)

(21) Appl. No.: 17/878,399

(22) Filed: Aug. 1, 2022

Related U.S. Application Data
(60) Provisional application No. 63/228,198, filed on Aug. 2, 2021.

(51) Int. Cl. G01V 3/12; G01C 21/00

(52) U.S. Cl. CPC G01V 3/12; G01C 21/3807

(57) ABSTRACT

A method and system for generating a map that shows subsurface structures includes the use of machine learning to develop a trained classifier that associates features in data with types of subsurface structures.

### CROSS-REFERENCE TO RELATED APPLICATIONS

This application claims the benefit of U.S. Application 63/228,198, filed Aug. 2, 2021, the contents of which are hereby incorporated by reference in their entirety.

### BACKGROUND

This invention relates to radar and in particular to the use of radar in connection with three-dimensional mapping of concealed or unobserved sections of infrastructure.

A significant amount of infrastructure lies on the other side of an impenetrable surface. For example, sewer pipes, water mains, and storm drains are typically buried under streets. Much electrical and communication infrastructure is also covered, for example by being behind or embedded in floors, walls, or ceilings. Many older cities also have underground networks of steam pipes that distribute pressurized steam to various buildings.

When carrying out a construction or maintenance project, it is often necessary to access the space behind this surface. This can result in an unplanned encounter with the covered infrastructure. Such an encounter can lead to undesirable results, including serious injury or death, property damage, and construction delays that may arise from a need to reroute utilities or to re-design of the project.

To avoid such unplanned encounters, it is known to piece together historical maps. However, some maps are of dubious accuracy. As such, it is typical to also dig test holes to confirm suspected locations of infrastructure.

Another useful method for locating the subsurface infrastructure is the use of ground-penetrating radar (GPR). However, correctly interpreting such radar returns requires considerable expertise. Experts who can perform this are in short supply.

### SUMMARY

The invention relates to the use of radiation, such as ground-penetrating radar, coupled with machine learning to create three-dimensional maps of the subsurface environment under an extended area for use by planning, design, permitting, construction, repair and maintenance personnel when carrying out excavations or other procedures for which an unplanned encounter with such infrastructure is a risk, designing new utility lines or structures in close proximity to existing subsurface infrastructure, assessing the condition of existing infrastructure, modeling the performance of existing infrastructure, assessing interference between existing and new infrastructure, and devising repair strategies or solutions

As used herein, an extended area is one that might encompass a town, a city, or a conurbation. The vast scale that is contemplated raises certain practical problems, the solutions of which are described herein.

In one aspect, the invention features a method that includes storing training data and target data in a radar database containing radar images or radargrams. Both the training data and the target data result from illumination by ground-penetrating radar. The method continues with dividing the training data into subdivisions, using an annotation interface, receiving annotations that associate features in the subdivisions with types of subsurface structures, and using the annotated subdivisions and the training data to develop a trained classifier. With the trained classifier now having been developed, the method further continues with dividing the target data into local maps, using the trained classifier to associate features in the local maps with types of subsurface structures, and aligning the local maps to form a global map that shows the subsurface structures. Examples of subsurface structures include subsurface defects, such as voids and tunnels, and infrastructure, such as pipes, wires, and cables.

In some embodiments, the method further includes providing the global map to an end user.

Among the practices are those that include identifying a structure that comprises a first portion in a first local map and a second portion in the second local map and aligning the subdivisions so as to establish continuity between the first and second portions. Among these practices are those in which establishing the continuity comprises aligning the first local map with the second local map such that the first portion and the second portion connect to each other. Also among these practices are those in which the structure is substantially linear, in which case the first and second portions are first and second segments. In such cases, establishing the continuity comprises aligning the first local map with the second local map such that a line extending along an axis of the first segment is colinear with a line that extends along an axis of the second segment, those in which establishing the continuity comprises aligning the first local map with the second local map such that a portion of the first segment overlaps a portion of the second segment, and those in which establishing the continuity comprises aligning the first local map with the second local map based on coordinates of the first and second segments and directions in which the first segment and the second segment extend.

In other practices, the method includes generating a navigation plan that comprises navigation paths that are to be traversed while carrying out the illumination by ground-penetrating radar. In some of these practices, the resulting navigation paths include two or more navigation paths that traverse the same street. In others, the resulting navigation paths include navigation paths that correspond to different lanes of the same street.

Practices include those in which the annotations associate features in the training data with types of manmade infrastructure and those in which the annotations associate features in the training data with types of natural features.

Still other practices include dividing the training data into subdivisions comprises selecting sizes of the subdivisions based on feature densities of the subdivisions. Among these are practices in which dividing the training data into subdivisions comprises choosing an area of a first subdivision having a first feature density to minimize a difference between a product of the area and a product of a feature density of a second subdivision and an area of the second subdivision.

In yet other practices, dividing the target data into local maps comprises choosing a ratio of an area of a first local map to a second local map to be as close as possible to a ratio of a feature density of the second local map to the first local map.

Further practices include those in which dividing the training data into subdivisions results in first and second subdivisions that at least partially overlap and those in which dividing the training data into subdivisions results in first and second subdivisions that are separated by a gap that is outside of any subdivision.

Yet other practices include those in which aligning the local maps comprises implementing a machine-learning process that includes creating a synthetic labeled training dataset, training the machine learning model using the synthetic labeled training set thus created, and using the trained classifier to process pairs of linear structures identified in the local maps.

In some practices, receiving annotations comprises receiving annotations that rely on one or more of: historical maps, test pits, core samples, previous scans or maps, visible manmade features, including those identified from above-ground videos, pictures, and site surveys, and the results of other non-destructive tests. For example, if two fire hydrants are visible in an above-ground image, it is reasonable to infer the existence of a water pipe between them. Thus, if a feature on a radar image extends between the locations of the two visible fire hydrants, it would be reasonable to infer that such a feature represents a water pipe. Annotating that feature as a water pipe would then provide a machine-learning system with a basis for knowing what a water pipe should look like in a radar image and therefore provide a basis for identifying a water pipe in another image.

In other practices, the training data and the target data result from illumination of sides of a tunnel and a ceiling of the tunnel.

Also, among the practices of the method are those in which the global map identifies locations of subsurface defects and locations of subsurface infrastructure.

In another aspect, the invention includes an apparatus for generating a global map that shows subsurface features. Such an apparatus includes a navigation system, a training system, a trained classifier, and a local-map integrator. The navigation system is configured to generate a navigation plan that comprises navigation paths that are to be traversed when detecting reflections arising as a result of having illuminated a training volume with ground-penetrating radar. The training system comprises a training component, a subdivider, an annotation interface, and a radar database. The training system receives training data that results from having traversed the navigation paths and stores the training data in the radar database for use in forming the trained classifier, the trained classifier having been trained to receive local maps of a target volume and to associate features in the local maps with types of structures, the local maps being based on target data that was acquired by scanning the target volume with ground-penetrating radar. The local-map integrator is configured to align the local maps of the target volume following annotation thereof by the trained classifier to form the global map of the target volume.

In some embodiments, the subdivider operates to divide a global map into computationally-manageable constituent local maps in such a way as to reduce differences in the computational loads associated with processing each of the local maps in an attempt to achieve the objective of having the computational loads associated with each local map be essentially the same. The subdivision depends at least in part on what computations are being contemplated.

For example, in some cases, the computation being contemplated concerns a feature with a particular spatial distribution whereas in other cases, the computation being contemplated concerns a different feature with a different spatial distribution. Naturally, the subdivider would subdivide the global map differently in each case.

Because of the dynamic nature of urban evolution, changes may occur in previously scanned regions. For example, a construction project may require installing new infrastructure or moving existing structure. As a result, it will, from time-to-time, be useful to update the global map. This generally proceeds with re-scanning the affected region and providing updated scan information to the local-map integrator, which then integrates the updated scan information into the existing global map.

Additionally, the sub-surface environment is not entirely static. For instance, at times of high groundwater level, the interaction of the sub-surface environment with an incident electromagnetic wave will differ from that which prevails at times of lower groundwater level. In some embodiments, it is useful for metadata to include such information so that it can be taken into account in assessing the data and so that a confidence level can be assigned to that data. In some embodiments. the local-map integrator provides such a confidence level.

The methods and systems described and claimed herein are limited to those that are implemented in a non-abstract manner. All descriptions of carrying out the methods and implementing systems in an abstract manner have been deliberately omitted from this description. As a result, the claims can only cover non-abstract implementations. As used herein, the term “non-abstract” shall be construed to mean the converse of “abstract” as that term has been defined by the Courts of the United States as of the filing of this application. Accordingly, any person who construes the claims as covering subject matter that is abstract would be a person who has failed to construe the claims in light of the specification.

All attempts to carry out the claimed subject matter using only pencil and paper or just the human mind have thus far failed. Based on experimental evidence thus far, it appears that the subject matter is not capable of being performed in the human mind alone even when assisted by pencil and paper or equivalents thereof.

The subject matter described and claimed herein has the technical effect of reducing risk associated with planning, design, maintenance, excavation, and construction.

Other features and advantages of the invention are apparent from the following description, and from the claims.

### DESCRIPTION OF DRAWINGS

FIG. 1 shows a fleet of vehicles outfitted for scanning with ground-penetrating radar.

FIG. 2 shows a system for developing a navigation plan for use in guiding the vehicles shown in FIG. 1;

FIG. 3 shows a section of a street map;

FIG. 4 shows a graph corresponding to the section shown in FIG. 3;

FIG. 5 shows a street that is represented by a single edge in a conventional street map;

FIG. 6 shows the street in FIG. 5 in an extended street map with multiple edges;

FIG. 7 shows a system for annotating raw data acquired by the vehicles of FIG. 1;

FIG. 8 shows subdivisions of a region scanned by the vehicles shown in FIG. 1;

FIG. 9 shows a training procedure based on the annotations provided in FIG. 7;

FIG. 10 shows the generation of global maps using the trained classifier from FIG. 9;

FIG. 11 shows FIG. 8 with features used for local map alignment having been identified;

FIG. 12 shows a concatenation between two segments of a linear structure;

FIG. 13 shows an interpolation between two segments of a linear structure; and

FIG. 14 shows a merger between two segments of a linear structure.

### DESCRIPTION

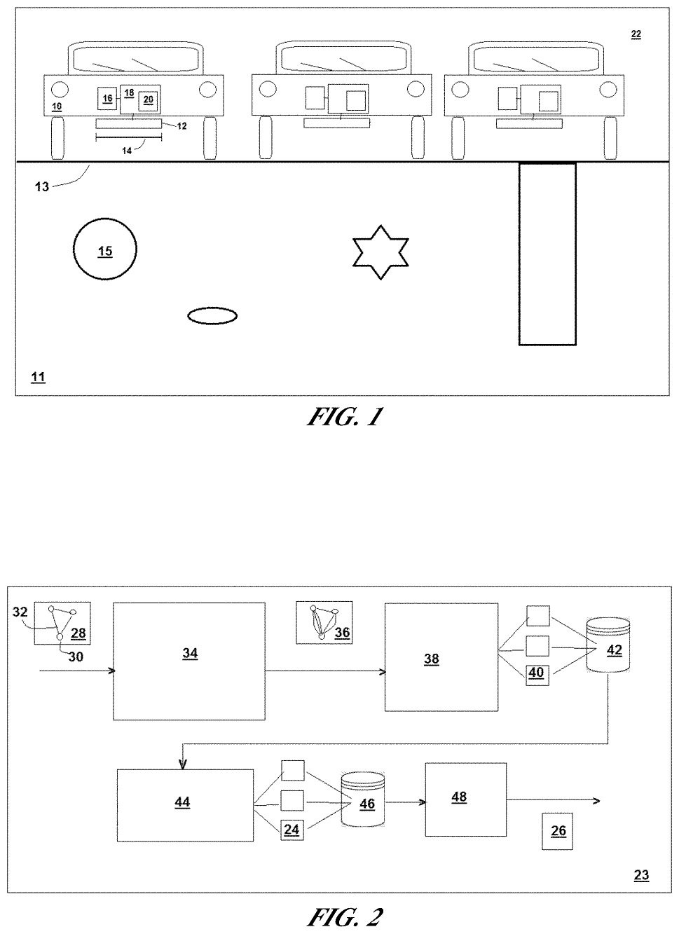

FIG. 1 shows a vehicle 10 outfitted with a radar system 12 for use in collecting radar returns. As used herein, “radar system” refers to “ground-penetrating radar system.” The radar system 12 is characterized by a scanning width 14. The scanning width 14 of the illustrated radar system 12 is exemplary only. Such radar systems 12 can be wider or narrower than that shown.

In the illustrated embodiment, the radar system 12 is shown as scanning the surface under the vehicle 10. However, in other embodiments, the radar system 12 is oriented to scan in another direction, such as to the side of the vehicle 10 or above the vehicle 10. This would be useful for scanning walls and ceiling of, for example, a tunnel.

In the illustrated embodiment, the vehicle 12 is an automobile. However, in some embodiments, the radar system 12 is mounted on a cart or towed vehicle, an aircraft or balloon, or weighted down and towed by a ship for purposes of scanning a seabed, such as the seabed that underlies a harbor in a developed area.

In other embodiments, the radar system 12 is mounted on a mechanical arm that can be positioned as needed to scan in various directions. In some embodiments, such an arm has a feedback arrangement and servo motor to permit scanning of an irregular surface.

The radar system 12 transmits an electromagnetic pulse into a sub surface volume 11 that lies behind a surface 13 that is impenetrable by radiation in the visible range. After a short delay, the radar system 12 receives a reflection from some structure 15 within the volume 11. Such a structure 15 is either man-made infrastructure or a natural feature.

Based on the coordinates of the surface 13 at which transmission occurred and reflection was detected as well as the delay between transmitting the pulse and receiving the reflection, it is possible to infer considerable information. Such information includes one or more of the three independent location coordinates, physical properties and geometry that specify the structure 15 that caused the reflection.

The vehicle 10 includes a geolocation unit 16 and a data collection system 18. The data collection system 18, which is coupled to both the geolocation unit 16 and the radar system 12, tags collected radar returns with metadata and stores the collected data in a data store 20. Such metadata includes the location at which the data was collected, as provided by the geolocation unit 16, the time it was collected, as well as details concerning equipment used for data collection. As shown in FIG. 1, the vehicle 10 is one of a fleet 22 of similar vehicles 10.

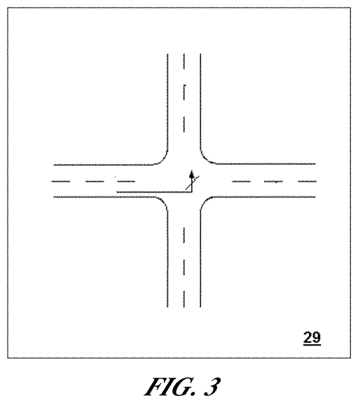

The process of collecting data in an efficient way requires that the vehicles 10 of the fleet 22 follow particular navigation paths 24. FIG. 2 shows a navigation system 23 for defining these navigation paths 24. The collection of navigation paths 24 defines a navigation plan 26.

The process of developing a navigation plan 26 includes obtaining a street map 28. Such a street map 28 is a graph in which nodes 30 and edges 32 represent intersections and streets, respectively. Each edge 32 in such a street map 28 corresponds to that portion of a street that extends between two intersections. As used herein, the term “street” is intended to encompass those structures that have properties of a “street,” including roads, bridges, tunnels, avenues, boulevards, freeways, turnpikes, trails, highways, paths, and the like, whether on public property or on private property.

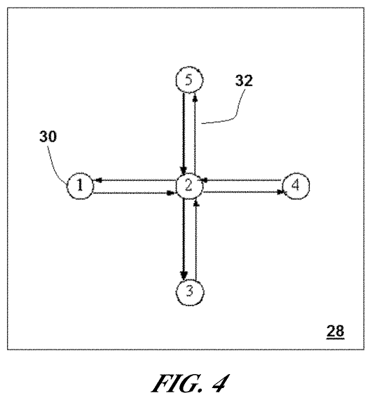

A street map 28 is typically available from any one of a variety of proprietary or open data sources (e.g., OPENSTREET™ map). FIG. 3 shows an example of an intersection 29 and FIG. 4 shows nodes 30 and edges 32 that represent the intersection 29 in a street map 28.

Within the navigation system 23, a graph extender 34 receives the street map 28 and duplicates certain of its edges 32 to produce an extended street map 36. The duplication of selected edges 32 arises from two considerations that are unique to the problem of capturing ground-penetrating radar returns over an extended area.

The first consideration arises because, as shown in FIG. 1, the radar system 12 can only scan along its finite scanning width 14. Therefore, a scanned structure, whether it be a street or some other type of structure, that is wider than this scanning width 14 cannot be scanned in one pass. Instead, it is necessary to make several passes, each of which is displaced in a direction transverse to the street's direction of travel by an amount that depends on the scanning width 14.

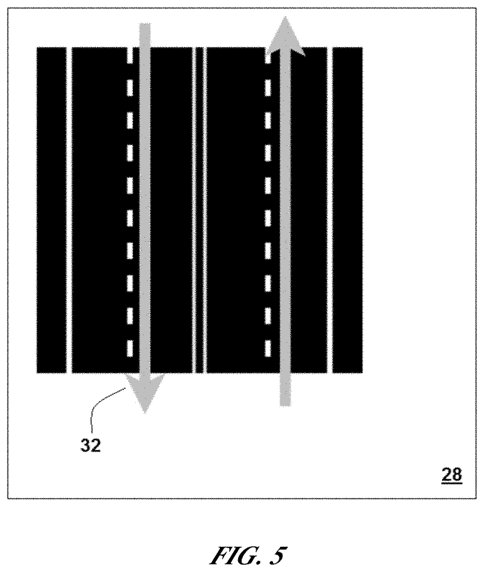

FIG. 5 shows a section from a conventional street map 28 in which each street corresponds to an edge 32. For purposes of knowing how to travel from one location to another, the actual width of a street is not relevant. Hence, a conventional street map 28 is free to consider each street as an edge.

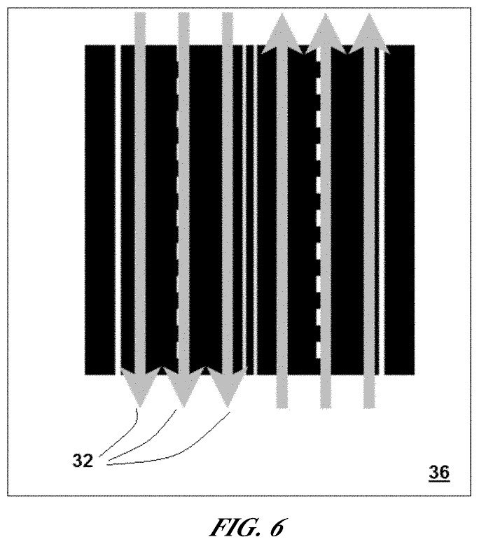

FIG. 6 shows a corresponding section from an extended-street map 36 in which, as a result of having been told of the scanning width 14 and knowing the width of the relevant is thrice the scanning width 14, the street shown in FIG. 5 has been made to correspond to three distinct edges 32. To correctly scan this street, the vehicle 10 must travel along each of the three edges 32 shown in FIG. 6.

The second consideration is that by scanning the same path multiple times, it becomes possible to average out noise in the resulting images. As a result, it is advantageous to scan the same street more than once.

The graph extender 34 returns an extended graph 36, which is then provided to a splitter 38 to be split into local graphs 40 that are then stored in a graph database 42. The need for the splitter 38 often arises from limitations in processing power. The splitter 38 executes a graph-partitioning process in which all streets in the local graph must be reachable. In some cases, two local graphs 40 share a common node 30. This provides a basis for joining the local graphs 40 to form a larger map.

A path generator 44 retrieves each local graph 40 from the database 42. For each retrieved local graph 40, the path generator 44 executes a process for identifying a closed navigation path 24 that visits every edge 32. Preferably, the identified navigation path 24 is the shortest such path that traverses every edge assigned to that navigation path 24. However, in some embodiments, the identified navigation path 24 is one that is shorter than some user-defined threshold. The navigation paths 24 are then saved in a path database 46.

A scheduler 48 retrieves the navigation paths 24 from the path database 46. The scheduler 48 uses the various navigation paths 24 to define the navigation plan 26. The scheduler 46 then assigns each vehicle 10 in the fleet 20 to collect data along a navigation path 24. In some cases, the scheduler 46 assigns two or more vehicles 10 to collect data in parallel within the same local graph 40. In others, the scheduler 46 assigns each vehicle 10 to its own local graph 40.

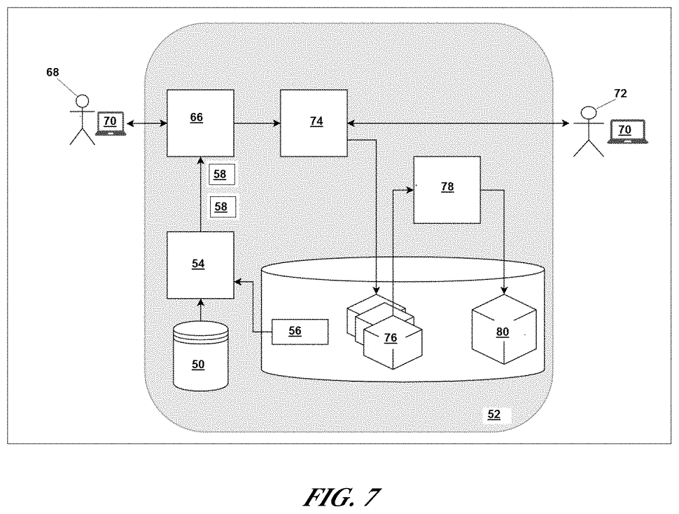

Referring now to FIG. 7, radar data collected by the fleet 22 after having followed the navigation plan 26 is stored in a radar database 50 on a cloud platform 52 to be prepared for annotation. The preparation for annotation begins with a subdivider 54 retrieving raw data from the radar database 50, associating it with metadata 56, and dividing it into manageable subdivisions 58.

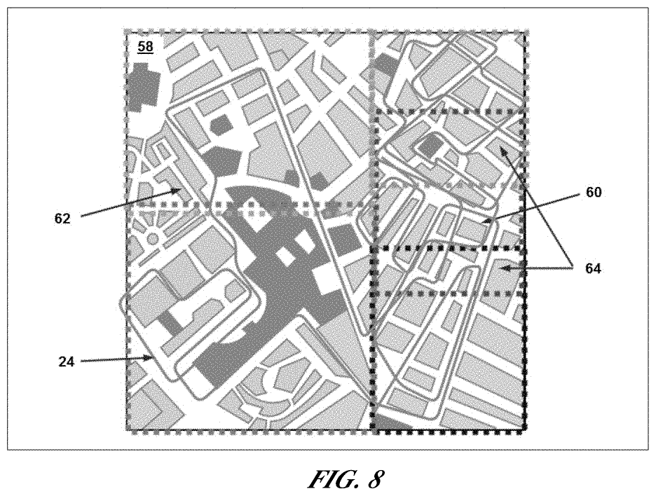

As a practical matter, the spatial distribution of infrastructure is not homogeneous. With reference to FIG. 8, a highly developed downtown area 60 may have considerable infrastructure. In contrast, in the outskirts 62 of a conurbation, there may be only limited infrastructure. Each infinitesimal scanned volume thus has an associated feature density. Therefore, for each subdivision, it is possible to evaluate a two-dimensional integral of feature density to obtain a measure of feature content associated with a particular subdivision 58, with the domain of integration being defined by the subdivision 58.

For purposes of annotation, it is useful to subdivide the raw data into subdivisions 58 to reduce the variance in feature content across subdivisions. Given the inhomogeneity of the feature distribution, this results in subdivisions 58 of different sizes, as shown in FIG. 8. For example, as shown in FIG. 8, the subdivision 58 at the outskirts 62 is larger than that in the downtown area 60.

In general, the feature density is unknown. To circumvent this difficulty, the subdivider 54 estimates feature density based on samples of the data collected and based on the length of the navigation path 24, with multiple passes over the same street being ignored for purposes of estimating feature density.

As shown in FIG. 8, the subdivisions 58 are quadrilateral. This is a convenient shape for tiling an area. However, other polygons can be used. In addition, it is not necessary tiling to be perfect. In general, because of vagaries in the data-gathering process, there may exist overlaps 64 between adjacent subdivisions or gaps between adjacent subdivisions.

The subdivider 54 carries out an iterative procedure in which a subdivision 58 is split into smaller subdivisions. For each of the resulting smaller subdivisions 58, the subdivider 54 carries out a similar procedure, thus dividing those smaller subdivisions 58 into even smaller subdivisions 58. This iterative procedure continues until a stop criterion is met. Examples of a stop criterion include a minimum size for a subdivision and a maximum feature density for a subdivision 58.

Referring back to FIG. 7, the resulting subdivisions 58 are provided to an annotation component 66. The annotation process is carried out with intervention by a human annotator 68 who connects to the annotation component 66 via an interface 70. Although only a single annotator 68 is shown, in general there will be several annotators 68 working in parallel on different subdivisions 58.

This process includes identifying and locating features in the radar data from the radar database 50, assigning each such feature a spatial coordinate, and drawing lines or points in a representation of the three-dimensional subsurface volume represented by the radar data. Examples of features include utility lines, subsurface irregularities, such as voids and cracks, and other structural elements.

This identification process requires highly trained individuals who are able to interpret the raw radar data in the radar database 50. However, the work carried out by the annotator 68 can be leveraged by providing the resulting correlation between the radar data and the features thus identified to a machine learning system.

A preferred embodiment includes a human quality-control specialist 72 who reviews the annotations provided by the set of human annotators 70 for consistency. The quality-control specialist 72 connects to a quality-control component 74 using an interface 70 similar to that used by the annotator 68. The quality-control specialist 72 assigns quality scores to annotations, provides feedback to specific annotators 70, and resolves discrepancies in annotations provided by different annotators 70. In some cases, the quality-control specialist 72 returns an annotation to the appropriate annotator 68 for validation thereof. In other cases, the quality-control specialist 72 validates an annotation, which is then inserted into a database of local maps 74, each of which is a three-dimensional map corresponding to one of the subdivisions 58.

A volumetric-map generator 78 retrieves the local maps 74 and integrates them into a global map 80, which is a three-dimensional map that represents a large area, such as a town, city, conurbation, or other large structure or site.

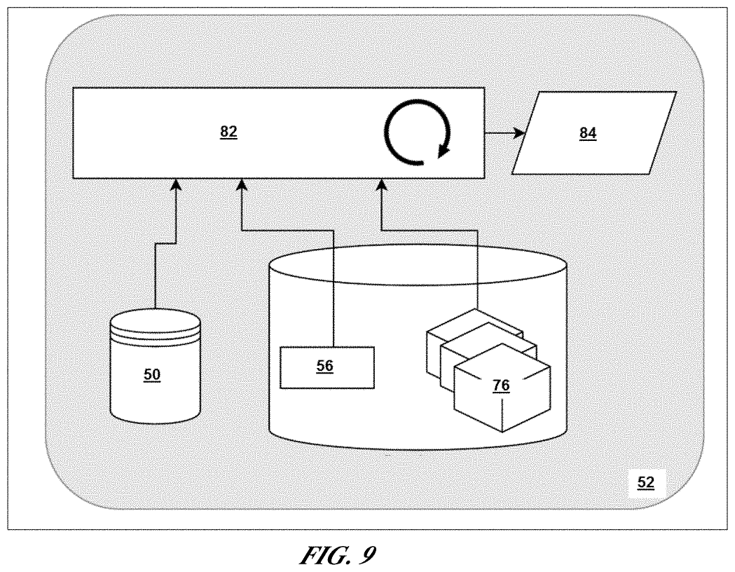

With a global map 80 now having been annotated, the next step, as shown in FIG. 9, is to have a training component 82 use the same raw data from the radar database 50, metadata 56, and local maps 76 to create a trained classifier 84 that is able to make further annotations based on the existing annotations.

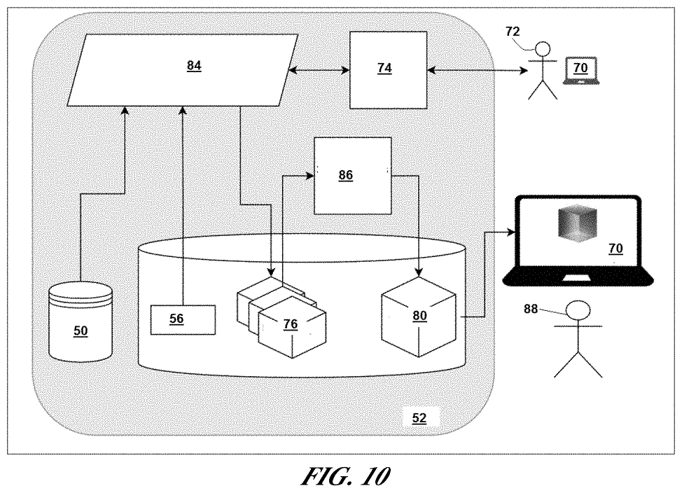

In a map-generation phase, shown in FIG. 10, the trained classifier 84 is put to work examining previously unseen radar data from the radar database 50. This unseen radar data differs from the training data that was used in connection with FIG. 7 and FIG. 9. The trained classifier 84 receives the radar data from the radar database 50 as well as its corresponding metadata 56. It then automatically generates corresponding new local maps 76.

Since it is unrealistic to expect the trained classifier 84 to be infallible, it is useful to provide a quality-control specialist 72 to inspect some of the trained classifier's output and to provide feedback to the trained classifier 84 when necessary. Upon being satisfied with the quality of the newly generated local maps 76, the quality-control specialist 72 releases the local maps 76 to a local-map integrator 86 to be used as a basis for generating a global map 80. This global map 80 is then made available to be viewed by an end user 88 using an interface 70.

Referring now to FIG. 11, a significant amount of subsurface infrastructure takes the form of essentially linear structures 90. Examples of such linear structures 90 are sewer pipes, water mains, and steam pipes. These linear structures 90 are likely to be much too long to fit within a particular local map 76. The term “linear structure” is used to identify structures that extend predominantly along one dimension and is not intended to require all of the properties of a “line” as defined in Euclidean geometry.

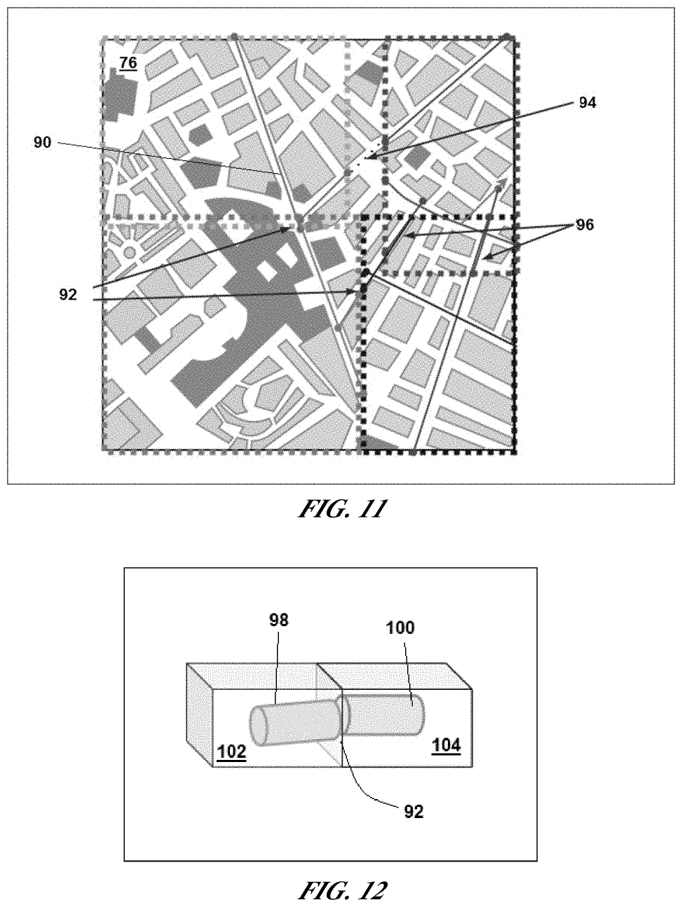

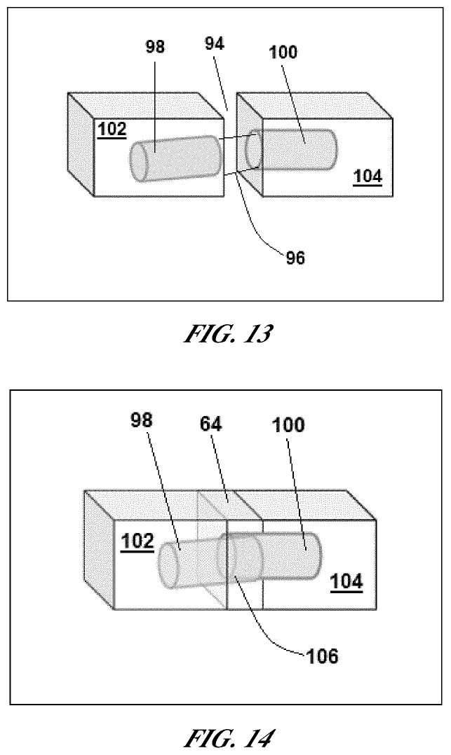

An important function of the local-map integrator 86 is that of aligning local maps 76 in such a way as to establish continuity of a structure 90 that extends over two or more local maps 76. In some cases, the data is such that the local-map integrator 86 is able to form a concatenation 92 of first and second segments 98, 100 of a linear structure 90 that extends across corresponding first and second local maps 102, 104, as shown in FIG. 12. In other cases, the radar data is such that a gap 94 exists, thus requiring the local-map integrator 86 to form an interpolation 96 of a missing segment that lies between the observed first and second segments 98, 100 of a structure 90, as shown in FIG. 13. In still other cases, local maps 76 form an overlap 64 between the first and second segments 98, 100 thus requiring the local-map integrator 86 to form a merger 106 between the structures 90, as shown in FIG. 14.

In some cases, there may be multiple structures 90 that extend over two or more local maps 76. As a result, there may not be enough degrees-of-freedom to align all of these structures 90. In such cases, it is useful to carry out a regression procedure in which the local maps 76 are aligned or merged in a way that minimizes an aggregate error associated with all structures 90. In such cases, it is useful to weight the structures 90 during the regression procedure based on confidence in those structures' locations or identities. This reduces the likelihood of attempting to merge artifacts that do not actually correspond to any real structure 90.

The local-map integrator 86 merges first and second structures 90 that have been identified in corresponding first and second local maps 76 using either machine learning or by using a heuristic method. The first and second local maps 76 of the pair are either adjoining, overlapping, or sufficiently close so that the probability that the first and second structures 90 are parts of the same structure 90 is higher than a pre-determined probability. These correspond to the cases illustrated in FIG. 12, FIG. 14, and FIG. 13 respectively.

Depending on the relationship between the first and second local maps 76, the merging process aligns the first and second local maps 76 to form the concatenation 92 of the first and second linear structures 90, as illustrated in FIG. 12, an interpolation 96 between the first and second linear structures 90 across the gap 94, as shown in FIG. 13, or a merger 106 of the first and second linear structures 90 within an overlap 64, as shown in FIG. 14.

A local-map integrator 86 that implements a heuristic process includes using a rapid screening test that relies on comparing coordinates of identified linear structures 90 based on GPS locations. This permits selection of a subset of the linear structures 90 for applying a more in-depth comparison that relies on locations and directions of first and second linear structures 90.

A local-map integrator 86 that implements a machine-learning process includes creation of a synthetic labeled training dataset, training of the machine learning model using the synthetic labeled training set thus created and using the trained classifier 84 to suitably process pairs of linear structures 90.

In a preferred embodiment, creating a synthetic labeled training dataset includes a split phase and a data-augmentation phase. The split phase includes randomly dividing identified linear structures 90 into segments. The data-augmentation phase includes randomly modifying the segments to simulate discrepancy of segments that have to be merged in real cases.

In some cases, the end user 88 carries out directional drilling to install, replace, or maintain underground utilities. Such a method avoids the requirement of digging a trench. As such, it avoids or reduces surface disturbance.

In such practices, the end user 88 uses global map 80 to guide a drill head so as to avoid an encounter with infrastructure identified in the global map 80. Embodiments include those in which the global map 80 is used to plan the path of a drill head as it makes its way to a target and those in which the global map 80 is used in real time to guide the movement of a drill head.

Embodiments in which the global map 80 is used to generate the drilling path typically include a map-generating step and a path-generating step.

In the map-generating step, which is illustrated in FIG. 10, the global map 80 is generated using a combination of ground-penetrating radar and one or more of historical maps, test pits, core samples, previous scans or maps, visible manmade features, including those identified from above-ground videos, pictures, and site surveys, and the results of other non-destructive tests. The resulting global map 80 includes such structures as physical objects and utility lines.

In the path-generating step, the global map 80 is used to generate a drilling path from entry point to target. Among these practices are those in which a path-generator automatically generates the path. The resulting path is then sent to construction equipment hardware or software to enable automatic or semi-automatic drilling or excavation.

In those embodiments in which the global map 80 is used in real time to guide the movement of a drill head, a drill-head controller receives the global map 80 and controls the drill head based on the global map 80 to adjust the drill head's path in real-time to avoid collisions with underground infrastructure as identified in the global map 80.

The case in which the end user 88 carries out real-time monitoring while drilling includes inserting the drill head into an entry point in a direction that corresponds to an expected path. This is followed by a scanning step in which a signal is transmitted to a volume ahead of the drill head in an effort to identify obstacles. Such a real-time signal can be based on methods such as ground-penetrating radar through a borehole, ultrasound, and X-ray. A signal indicative of obstacles in the path is continuously received and interpreted to produce a local representation of underground objects. Interpretation of these received signals to produce the local representation of objects may or may not be automated through an algorithm. This is followed by a path-adjustment step in which the drill head's expected path is recalculated based on the latest position and the surrounding objects. The foregoing steps are then repeated as needed until the drill head arrives at its target point.

In other cases, the end user 88 is particularly interested in maintenance and repair of existing infrastructure. For such cases, it is useful to detect subsurface voids or cracks under or around existing infrastructure, such as roads, runways, or tunnels, and to detect damage that may not be visible by an above-ground observer. In such cases, the technique used to generate the global map 80 in FIG. 10 is applied to create a global map 80 that shows subsurface defects.

A process for creating such a global map 80 includes scanning with a remote sensing system in the manner already described and receiving, via the annotation interface 66, annotations that focus specifically on association of data with subsurface defects. Examples of a remote-sensing system include those that rely on interaction with electromagnetic waves and those that rely on interaction with acoustic waves. These include systems that rely on ground-penetrating radar, those that rely on X-rays, and those that rely on ultrasonic waves. Embodiments that rely on shorter wavelengths, such as X-rays, are particularly useful as a result of increased resolution. In such embodiments, additional shielding is useful to avoid stray ionizing radiation.

The global map 80 that results would then identify locations of subsurface defects, which can then be made the subject of an analytical model. Such an analytical model provides additional information but at the cost of greater computational load. An example of an analytical model is a finite-element model. Based on the result of such modeling, it is possible to obtain information concerning position and dimension of a void needing repair and a measure of the extent to which the need to repair is critical. The process continues with the transmission of suitable instructions for repair to one or more controllers used to control construction equipment that is configured to effect the repair.

The methods described herein do not require any particular orientation for the surface that conceals the infrastructure. The most common such surface is the ground, in which the radar system 12 points downward into the ground. However, in some cases, the vehicle 10 traverses a tunnel. In such cases, it is useful to provide a radar system 12 that transmits into the sides or ceiling of the tunnel. In the context of the claims, reflection that results from illuminating the ceiling or wall of a tunnel is a reflection from an underground structure or buried structure since such a structure would necessary be below the level of the ground and buried within an underground volume. Thus, the mere fact that the radar system 12 is also underground when in a tunnel does not change anything.

In some cases, it is useful to mark a pavement's surface with markings that show the locations of underground infrastructure. Such markings are typically painted on using different colors to identify the different kinds of underground features. The locations of the painted markings indicate approximate locations of those features. The presence of such markings provides construction crews with some guidance on where to excavate so as to avoid unplanned encounters with existing infrastructure.

In such cases, a user 88 provides a robotic printing system with a global map 80 to use as a basis for automatically painting the surface of the pavement to accurately identify locations and types of underground infrastructure. Such a robotic printing system would include a robotic arm having a painting head mounted at a distal end thereof. The global map 80, in conjunction with a geo-positioning system, enables the robotic printing system to accurately paint markings on the pavement.

In other cases, the end user 88 is particularly interested in identifying illicit subsurface manmade tunnels. For such cases, it is useful to detect subsurface tunnels across national borders or urban centers. In such cases, the technique used to generate the global map 80 in FIG. 10 is applied to create a global map 80 that shows subsurface tunnels.

A process for creating such a global map 80 includes scanning with a remote sensing system in the manner already described and receiving, via the annotation interface 66, annotations that focus specifically on association of data with subsurface tunnels. Examples of a remote-sensing system include those that rely on interaction with electromagnetic waves and those that rely on interaction with acoustic waves. These include systems that rely on ground-penetrating radar, those that rely on X-rays, and those that rely on ultrasonic waves.

Having described the invention and a preferred embodiment thereof, what is claimed as new and secured by Letters Patent is:

1. A method comprising storing training data and target data in a radar database, said training data and said target data both resulting from illumination by ground-penetrating radar, dividing said training data into subdivisions, using an annotation interface, receiving annotations that associate features in said subdivisions with types of subsurface structures, using said annotated subdivisions and said training data to develop a trained classifier, dividing said target data into local maps, using said trained classifier to associate features in said local maps with types of subsurface structures, aligning said local maps to form a global map showing said subsurface structures, and providing said global map to an end user.

2. The method of claim 1, wherein said local maps comprise first and second local maps, wherein said method further comprises identifying a structure that comprises a first segment in said first local map and a second segment in said second local map, and wherein aligning said subdivisions comprises establishing continuity between said first and second segments.

3. The method of claim 2, wherein establishing said continuity comprises aligning said first local map with said second local map such that said first segment and said second segment connect to each other.

4. The method of claim 2, wherein establishing said continuity comprises aligning said first local map with said second local map such that a line extending along an axis of said first segment is colinear with a line that extends along an axis of said second segment.

5. The method of claim 2, wherein establishing said continuity comprises aligning said first local map with said second local map such that a portion of said first segment overlaps a portion of said second segment.

6. The method of claim 2, wherein establishing said continuity comprises aligning said first local map with said second local map based on coordinates of said first and second segments and directions in which said first segment and said second segment extend.

7. The method of claim 1, further comprising generating a navigation plan that comprises navigation paths that are to be traversed while carrying out said illumination by ground-penetrating radar, wherein said navigation paths comprise first and second navigation paths that are along a first street.

8. The method of claim 1, further comprising generating a navigation plan that comprises navigation paths that are to be traversed while carrying out said illumination by ground-penetrating radar, wherein said navigation paths comprise first and second navigation paths that correspond to first and second lanes of a first street.

9. The method of claim 1, wherein said annotations associate features in said training data with types of man-made infrastructure.

10. The method of claim 1, wherein said annotations associate features in said training data with types of natural features.

11. The method of claim 1, wherein dividing said training data into subdivisions comprises selecting sizes of said subdivisions based on feature densities of said subdivisions.

12. The method of claim 1, wherein dividing said training data into subdivisions comprises choosing an area of a first subdivision having a first feature density to minimize a difference between a product of said area and a product of a feature density of a second subdivision and an area of said second subdivision.

13. The method of claim 1, wherein dividing said target data into local maps comprises choosing a ratio of an area of a first local map to a second local map to be as close as possible to a ratio of a feature density of said second local map to said first local map.

14. The method of claim 1, wherein dividing said training data into subdivisions results in first and second subdivisions that at least partially overlap.

15. The method of claim 1, wherein dividing said training data into subdivisions results in first and second subdivisions that are separated by a gap that is outside of any subdivision.

16. The method of claim 1, wherein aligning said local maps comprises implementing a machine-learning process that includes creating a synthetic labeled training dataset, training the machine learning model using the synthetic labeled training set thus created, and using the trained classifier to process pairs of linear structures identified in said local maps.

17. The method of claim 1, wherein receiving annotations comprises receiving annotations that rely on historical maps and test pits.

18. The method of claim 1, wherein said training data and said target data result from illumination of sides of a tunnel and a ceiling of said tunnel.

19. The method of claim 1, wherein said global map identifies locations of subsurface defects and locations of buried infrastructure.

20. An apparatus for generating a global map that shows subsurface features, said apparatus comprising: a navigation system, a training system, a trained classifier, and a local-map integrator, wherein said navigation system is configured to generate a navigation plan that comprises navigation paths that are to be traversed when detecting reflections arising as a result of having illuminated a training volume with ground-penetrating radar, wherein said training system comprises a training component, a subdivider, an annotation interface, and a radar database, wherein said training system receives training data that results from having traversed said navigation paths and stores said training data in said radar database for use in forming said trained classifier, said trained classifier having been trained to receive local maps of a target volume and to associate features in said local maps with types of structures, said local maps being based on target data that was acquired by scanning said target volume with ground-penetrating radar, and wherein said local-map integrator is configured to align said local maps of said target volume following annotation thereof by said trained classifier to form said global map of said target volume. wherein said training system comprises a subdivider, an annotation interface, and a training component, wherein said subdivider is configured to divide data from said radar database into subdivisions, wherein said annotation interface is configured to receive annotations for said first subdivisions, wherein said annotations associate features in said first data with types of structure, wherein said training component is configured to train a classifier to form said trained classifier.
